(19) United States
(12) Patent Application Publication
(10) Pub. No.: US 2016/0172800 A1
(43) Pub. Date: Jun. 16, 2016

(54) UNIVERSAL SERIAL BUS JACK, UNIVERSAL SERIAL BUS PLUG AND UNIVERSAL SERIAL BUS CONNECTOR ASSEMBLY

(71) Applicants: HONG FU JIN PRECISION INDUSTRY (Wuhan) CO., LTD., Wuhan (CN); HON HAI PRECISION INDUSTRY CO., LTD., New Taipei (TW)

(72) Inventors: WEI-YING GONG, Wuhan (CN); CHUN-SHENG CHEN, New Taipei (TW)

(21) Appl. No.: 14/605,257

(22) Filed: Jan. 26, 2015

(30) Foreign Application Priority Data
Dec. 12, 2014 (CN) 201410760671.8

(51) Int. Cl. H01R 24/60; H01R 12/70

(52) U.S. Cl. CPC H01R 24/60; H01R 12/7082; H01R 2107/00

(57) ABSTRACT

A universal serial bus (USB) jack includes a case and an installation portion located in the case. The case is configured to receive a USB plug and includes a top wall and a bottom wall opposite to the top wall. The installation portion has a top surface facing the top wall and a bottom surface facing the bottom wall. A pair of coupling pins is attached to each of the top surface and the bottom surface. The two pairs of coupling pins are configured to couple to a pair of connecting pins of the USB plug in two opposite directions. The patent disclosure further discloses a USB plug which can be coupled to the USB jack and a USB connector assembly.

### FIELD

The subject matter herein generally relates to universal serial bus (USB) jacks, USB plugs, and USB connector assemblies.

### BACKGROUND

A fool-proofing structure or an inserting direction mark is generally used in a USB jack and a USB plug to prevent wrong coupling between the USB jack and the USB plug.

### BRIEF DESCRIPTION OF THE DRAWINGS

Implementations of the present technology will now be described, by way of example only, with reference to the attached figures.

FIG. 1 is an isometric view of an embodiment of a USB jack.

FIG. 2 is an isometric view of an embodiment of a USB plug.

FIG. 3 is an exploded, isometric view of an embodiment of a USB connector assembly comprising the USB jack and the USB plug.

FIG. 4 is an assembled, isometric view of the USB connector assembly of FIG. 3.

FIG. 5 is another assembled, isometric view of the USB connector assembly of FIG. 3.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

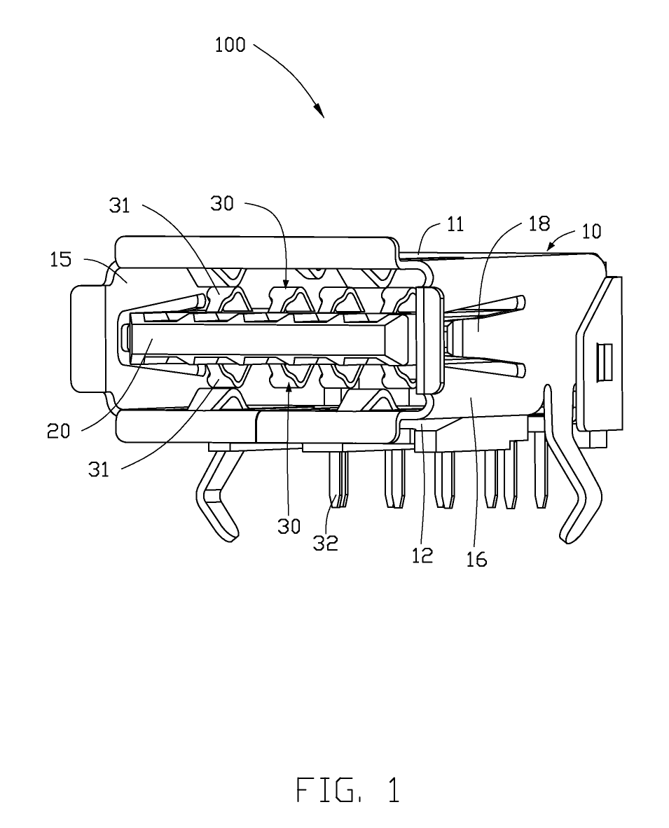

FIG. 1 illustrates a USB jack 100 of a USB connector assembly in accordance with an embodiment including a case 10 and an installation portion 20 located on the case 10.

The case 10 can include a top wall 11, a bottom wall 12, a rear wall 13, a first sidewall 15, and a second sidewall 16 opposite to the first sidewall 15. In one embodiment, the rear wall 13 is substantially perpendicular to the top wall 11 and the bottom wall 12, and the first sidewall 15 is substantially perpendicular to the top wall 11 and the rear wall 13. The installation portion 20 extends substantially perpendicularly from the rear wall 13. The installation portion 20 has a top surface facing the top wall 11, and a bottom surface facing the bottom wall 12. A pair of coupling pins 30 is attached to each of the top surface and the bottom surface. Each pair of coupling pins 30 can be coupled to a USB 2.0 plug or a USB 3.0 plug. In at least one embodiment, a number of each pair of coupling pins 30 is 9. The two pairs of coupling pins 30 are symmetrically arranged relative to the installation portion 20. A distance between the top wall 11 and the top surface of the installation portion 20 is substantially equal to a distance between the bottom wall 12 and the bottom surface of the installation portion 20. A plurality of resilient pieces 18 extends from each of the top wall 11, the bottom wall 12, the first sidewall 15, and the second sidewall 16.

Each coupling pin 30 has a first end 31 and a second end 32 opposite to the first end 31. The first end 31 is secured to the installation portion 20. The second end 32 extends out of the case 10 through the rear wall 13. Each second end 32 merges with two same first ends 31 of the two pairs of coupling pins 30. A number of the second ends 32 are equal to a number of each pair of coupling pins 30.

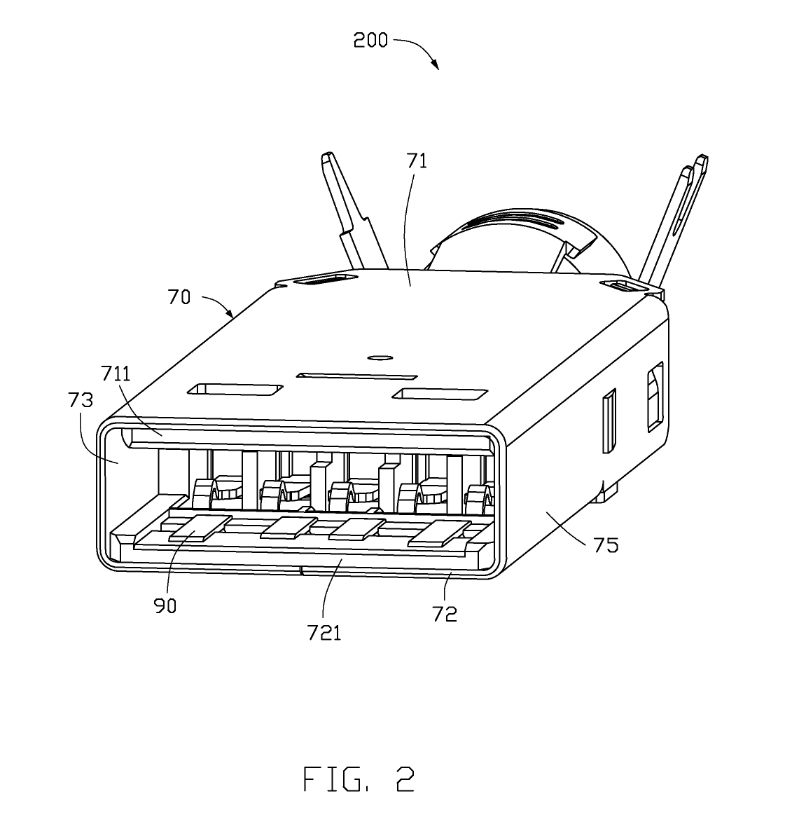

FIG. 2 illustrates a USB plug 200 of a USB connector assembly in accordance with an embodiment including a housing 70 and a pair of connecting pins 90 located in the housing 70.

The housing 70 can include a top plate 71, a bottom plate 72, a first side plate 73 and a second side plate 75. In one embodiment, the top plate 71 is substantially parallel to the bottom plate 72; the first side plate 73 is substantially parallel to the second side plate 75 and substantially perpendicular to the top plate 71. A top rib 711 extends downwards from the top plate 71. A bottom rib 721 extends upwards from the bottom plate 72. The pair of connecting pins 90 is attached to a top surface of the bottom rib 721 facing the top rib 711. Each connecting pin 90 couples to a USB cable. A thickness of the top rib 711 is substantially equal to a thickness of the bottom rib 721. In at least one embodiment, the USB plug 200 can be a USB 2.0 plug and a USB 3.0 plug, and a number of the connecting pins 90 are 9.

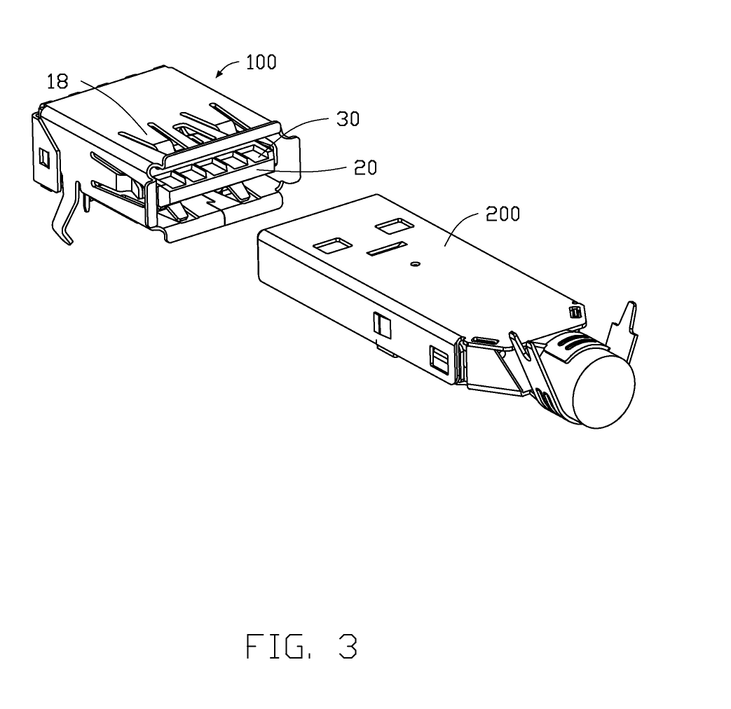

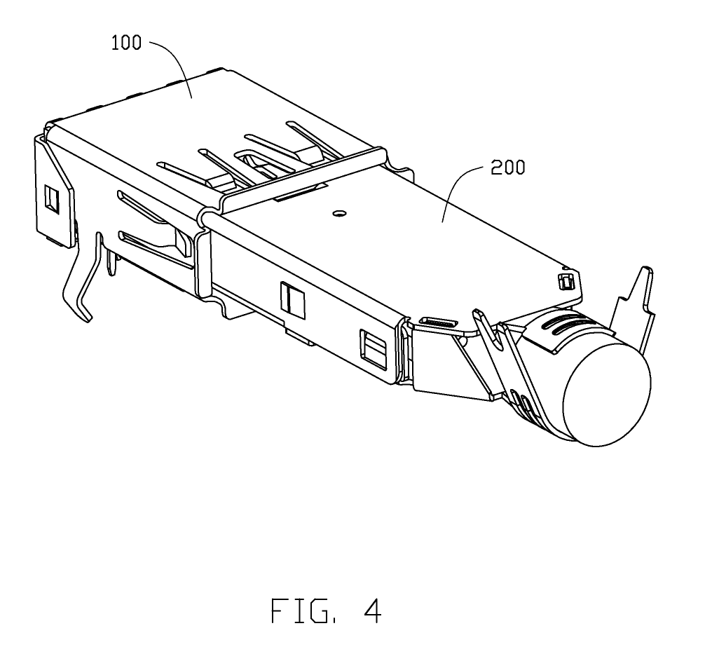

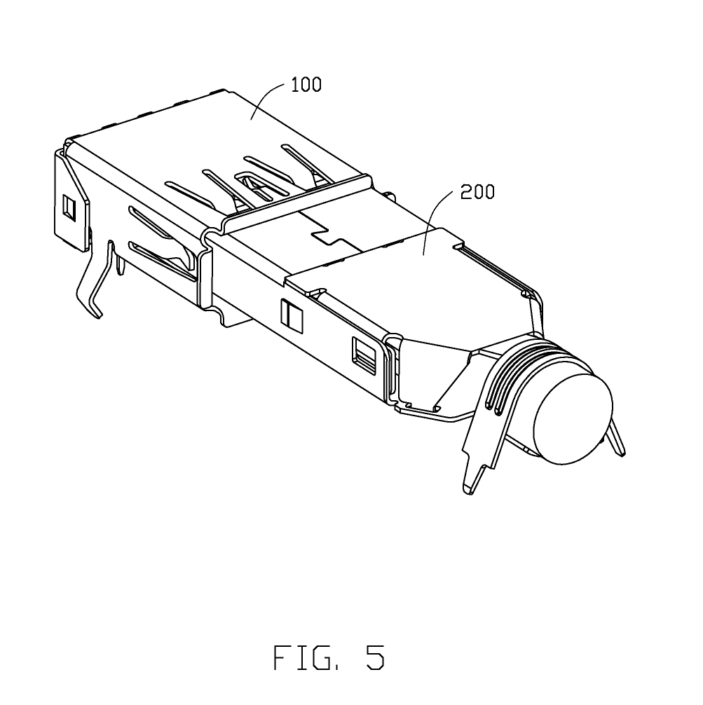

FIGS. 3-5 illustrate that in assembly of the USB jack 100 and the USB plug 200. The USB plug 200 is moved towards the USB jack 100, the housing 70 is adjacent to the USB jack 100. The top plate 71 abuts the top wall 11. The bottom plate 72 abuts the bottom wall 12. The housing 70 is inserted into the case 10, until blocked by the rear wall 13. The pair of connecting pins 90 is coupled to one of the two pairs of coupling pins 30. The top rib 711 and the top plate 71 are located between the top wall 11 and the top surface of the installation portion 20. The bottom rib 721 and the bottom plate 72 are located between the bottom wall 12 and the bottom surface of the installation portion 20. Thus, the USB plug 200 can be inserted into the USB jack 100 in any direction.

The embodiments shown and described above are only examples. Many details are often found in the art such as the other features of a USB jack, USB plug and USB connector assembly. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A universal serial bus (USB) jack, comprising:
a case configured to receive a USB plug and comprising a top wall and a bottom wall opposite to the top wall;
an installation portion located in the case and having a top surface facing the top wall and a bottom surface facing the bottom wall; and
a pair of coupling pins attached to each of the top surface and the bottom surface;
wherein the two pairs of coupling pins are configured to couple to a pair of connecting pins of the USB plug in two opposite directions.

2. The USB jack of claim 1, wherein a distance between the top surface and the top wall is substantially equal to a distance between the bottom surface and the bottom wall.

3. The USB jack of claim 1, wherein the two pairs of coupling pins are symmetrically arranged relative to the installation portion.

4. The USB jack of claim 1, wherein the case further comprises a rear wall coupled to the top wall and the bottom wall, each coupling pin has a first end and a second end, the first end is attached to the installation portion, and the second end extends out of the rear wall to couple to a printed circuit board.

5. The USB jack of claim 4, wherein the installation portion extends from the rear wall and is substantially perpendicular to the rear wall, and the rear wall is substantially perpendicular to the top wall and the bottom wall.

6. The USB jack of claim 4, wherein each second end is a confluence by two same first ends of the two pairs of coupling pins.

7. The USB jack of claim 1, wherein the case further comprises a resilient piece extending from each of the top wall and the bottom wall.

8. A universal serial bus (USB) plug, comprising:
a housing configured to be inserted into a USB jack and comprising a top plate and a bottom plate opposite to the top plate;
a top rib extending downwards from the top plate;
a bottom rib extending upwards from the bottom plate; and
a pair of connecting pins attached to the bottom rib;
wherein the pair of connecting pins are configured to couple to a pair of coupling pins of the USB jack.

9. The USB plug of claim 8, wherein a thickness of the top rib is substantially equal to a thickness of the bottom rib.

10. A universal serial bus (USB) connector assembly, comprising:
a USB jack comprising:
a case comprising a top wall and a bottom wall opposite to the top wall;
an installation portion located in the case and having a top surface facing the top wall and a bottom surface facing the bottom wall; and
a pair of coupling pins attached to each of the top surface and the bottom surface;
a USB plug comprising:
a housing comprising a top plate and a bottom plate opposite to the top plate;
a top rib extending downwards from the top plate;
a bottom rib extending upwards from the bottom plate; and
a pair of connecting pins attached to the bottom rib;
wherein the pair of connecting pins is engageable with each of the two pairs of coupling pins to couple the USB plug to the USB jack.

11. The USB connector assembly of claim 10, wherein a distance between the top surface and the top wall is substantially equal to a distance between the bottom surface and the bottom wall.

12. The USB connector assembly of claim 10, wherein the two pairs of coupling pins are symmetrically arranged relative to the installation portion.

13. The USB connector assembly of claim 10, wherein the case further comprises a rear wall coupled to the top wall and the bottom wall, each coupling pin has a first end and a second end, the first end is attached to the installation portion, and the second end extends out of the rear wall to couple to a printed circuit board.

14. The USB connector assembly of claim 13, wherein the installation portion extends from the rear wall and is substantially perpendicular to the rear wall, and the rear wall is substantially perpendicular to the top wall and the bottom wall.

15. The USB connector assembly of claim 13, wherein each second end is a confluence by two same first ends of the two pairs of coupling pins.

16. The USB connector assembly of claim 10, wherein the case further comprises a resilient piece extending from each of the top wall and the bottom wall.

17. The USB connector assembly of claim 10, wherein a thickness of the top rib is substantially equal to a thickness of the bottom rib.

18. The USB connector assembly of claim 10, wherein the top rib and the top plate are located between the top wall and the top surface of the installation portion.

19. The USB connector assembly of claim 10, wherein the bottom rib and the bottom plate are located between the bottom wall and the bottom surface of the installation portion.
